(19) United States
(12) Patent Application Publication
(10) Pub. No.: US 2013/0135086 A1
(43) Pub. Date: May 30, 2013

(54) ARTICLE-TRACKING SYSTEM AND METHOD USING RFID TAGS

(71) Applicants: HSIN-PEI CHANG, Tu-Cheng (TW); ZONG-YUAN SUN, Tu-Cheng (TW); DA-HUA XIAO, Shenzhen City (CN)

(72) Inventors: HSIN-PEI CHANG, Tu-Cheng (TW); ZONG-YUAN SUN, Tu-Cheng (TW); DA-HUA XIAO, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/596,034

(22) Filed: Aug. 27, 2012

(30) Foreign Application Priority Data
Nov. 28, 2011 (CN) 201110383674.0

(51) Int. Cl. G06K 7/01

(52) U.S. Cl. 340/10.4

(57) ABSTRACT

A control unit for tracking articles is positioned approximate to a package and communicates with a radio frequency identification (RFID) reader. The control unit includes a RFID tag, a storage, a switch, and a microcontroller. The switch outputs a first control signal to the microcontroller if the package is opened, the microcontroller outputs an open status signal and a corresponding real-time clock (RTC) signal to the storage according to the first control signal, the RFID tag sends the open status signal and the corresponding RTC signal from the storage to the RFID reader in due course.

### CROSS-REFERENCE TO RELATED APPLICATIONS

This application is one of the three related co-pending U.S. patent applications listed below. All listed applications have the same assignee. The disclosure of each of the listed applications is incorporated by reference into each of the other listed applications.

| Attorney | | |
|---|---|---|
| Docket No. | Title | Inventors |
| US 42979 | ARTICLE-TRACKING SYSTEM AND | HSIN-PEI |
| | METHOD USING RFID TAGS | CHANG et al. |
| US 43084 | ARTICLE-TRACKING SYSTEM AND | HSIN-PEI |
| | METHOD USING RFID TAGS | CHANG et al. |
| US 43160 | ANTI-THEFT SYSTEM USING RFID | HSIN-PEI |
| | TAGS | CHANG et al. |

### BACKGROUND

1. Technical Field

The disclosure generally relates to article-tracking systems, and particularly relates to a system of tracking articles using radio frequency identification (RFID) tags and a method thereof.

2. Description of the Related Art

Tracking and verification of articles has evolved in transportation business through the use of RFID tags. RFID tags can be attached to articles and be packed in a package (e.g., a box). However, the articles in the boxes may be stolen or replaced by fakes during the transportation process if one can open the package without detection before delivery of the package, and this will cause economic loss for manufacturers and sellers.

Therefore, there is room for improvement within the art.

### BRIEF DESCRIPTION OF THE DRAWINGS

Many aspects of an exemplary article-tracking system and method using RFID tags can be better understood with reference to the drawings. The components in the drawings are not necessarily drawn to scale, the emphasis instead being placed upon clearly illustrating the principles of the disclosure.

FIG. 1 is a schematic view of an article-tracking system using RFID tags, according to an exemplary embodiment.

FIG. 2 is a block diagram of a control unit of the article-tracking system using RFID tags as shown in FIG. 1.

### DETAILED DESCRIPTION

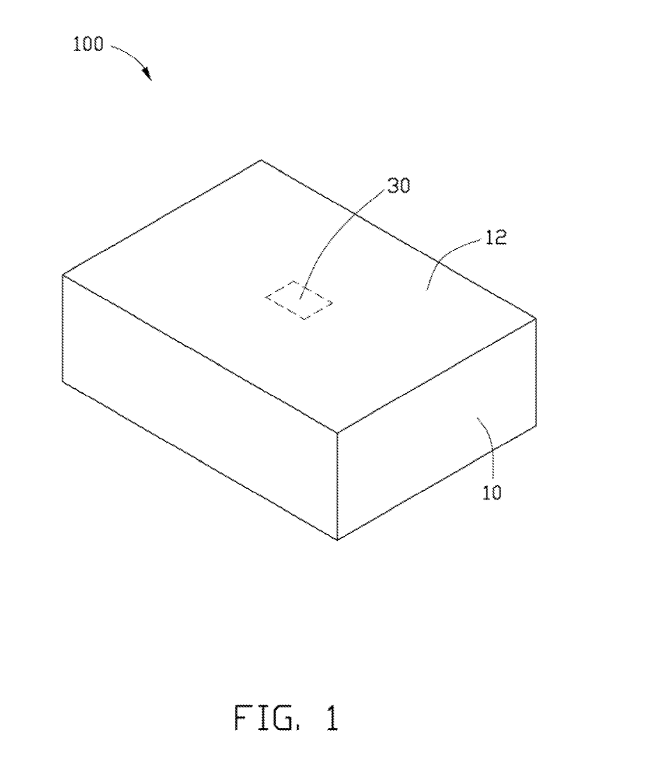

FIG. 1 is a schematic view of an article-tracking system 100 using RFID tags, according to an exemplary embodiment. The article-tracking system 100 can track articles by means of RFID tags included during packing, transportation, and verification processes of the articles. The article-tracking system 100 includes a package 10 and a control unit 30. The articles can be luxury cigarettes, clothes, computers, or confidential files, for example.

The package 10 can be a box or any suitable storage container to accommodate the articles. The package 10 includes a cover 12 (e.g., a lid or the top of a box) where the articles are packed in the package 10, and then the cover 12 can be sealed.

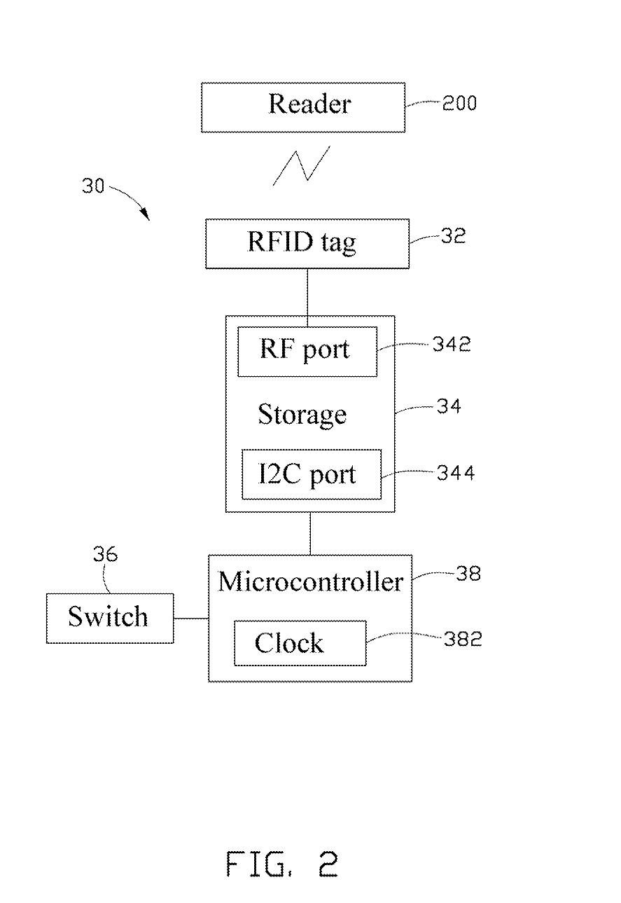

Referring to FIG. 2, the control unit 30 can be positioned on the cover 12 or any position approximate to a surface of the package 10, and includes a RFID tag 32, a storage 34, a switch 36, and a microcontroller 38. The storage 34 is electronically connected between the RFID tag 32 and the microcontroller 38, and the switch 36 is electronically connected to the microcontroller 38.

The RFID tag 32 communicates with a reader 200 via radio frequency (RF) signals, for receiving clock signals from the reader 200 and feeding back data to the reader 200 which is used to track the articles (tracking data). The tracking data may include open/closed status signals and corresponding real-time clock (RTC) signals, the open/closed status signals may be digital signals such as logic “1” or logic “0”, and the digital signals can represent that the cover 12 is in an open/closed status. In one exemplary embodiment, the operating frequency of the RFID tag 32 can be 125 KHz, 13.56 MHz, 433 MHz, 900 MHz, 2.45 GHz, or 5.8 GHz.

In one exemplary embodiment, the storage 34 can be an electrically erasable programmable read-only memory (EEPROM) including a radio frequency (RF) port 342 and an inter-integrated circuit (I2C) port 344. The RF port 342 is electronically connected to the RFID tag 32, and the I2C port 344 is electronically connected to the microcontroller 38. Thus, the storage 34 can temporarily store the clock signals from the RFID tag 32 and the tracking data from the microcontroller 38, and then the RFID tag 32 can read the tracking data via the RF port 342, and the microcontroller 38 can read the clock signals via the I2C port. The storage 34 may be repeatedly utilized because the clock signals and the tracking data stored in the EEPROM can be easily erased.

The switch 36 may be a mechanical switch or an electrical switch. The switch 36 is configured for outputting a first control signal confirming an open status and a second control signal in response to a closed status in respect of the cover 12. If the cover 12 is open, the switch 36 outputs the first control signal (e.g., logic 0). If the cover 12 is closed, the switch 36 outputs the second control signal (e.g., logic 1).

In one exemplary embodiment, the microcontroller 38 includes a clock 382. The microcontroller 38 reads the previous clock signals recorded in the storage 34, and sets or resets the clock 382 accordingly. The microcontroller 38 receives the first control signal or the second signal output from the switch 36, and then reads the RTC signal from the clock 382. In one embodiment, the microcontroller 38 may be in an initial sleep state before receiving the first control signal or the second signal output from the switch 36, in order to conserve power. Upon receiving the first control signal or the second signal, the microcontroller 38 goes to an on state from the sleep state.

Additionally, the microcontroller 38 predetermines a threshold period of time (e.g., 100 ms). The microcontroller 38 determines whether a time difference between receiving the first signal and the second signal is less than the threshold time period, and then transmits the open/closed status signals and the corresponding RTC signal to the storage 34 according to the determination. If the time difference between receiving the first signal and the second signal is more than the threshold time period, the microcontroller 38 will transmit the open/closed status signals and the corresponding RTC signal to the storage 34. In this condition, the package 10 may be opened or/and closed by manual manipulation of the cover 12. If the time difference between receiving the first signal and the second signal is not more than the threshold time period, the microcontroller 38 will not transmit the open/closed status signals and the corresponding RTC signal to the storage 34. In this condition, the package 10 may be opened or/and closed by other actions, such as a mechanical vibration of the cover 12, for example.

An article-tracking method of the aforementioned article-tracking system 100 is described according to an exemplary embodiment. The article-tracking method includes at least following steps:

In step S1, during the packing process, the article(s) are packed in the package 10, and the cover 12 is sealed. Then, the RFID tag 32 communicates with the reader 200 to receive clock signals from the reader 200, and then the RFID tag 32 transmits the clock signals to the storage 34 via the RF port 342. The microcontroller 38 reads the clock signals from the storage 34 via the I2C port 344, and accordingly sets or resets the clock 382 to allow the clock 382 to begin counting. Then, the microcontroller 38 can enter into the sleep state for conserving power. For example, the cover 12 might be closed at 8:50, and the clock 382 would begin to counting from 8:50.

In step S2, during the transportation process of the article(s), the switch 36 outputs the first control signal to the microcontroller 38 if the cover 12 is opened, and outputs the second control signal if the cover 12 is then closed after being opened. For example, the cover 12 may be opened at 15:20, and closed at 15:35. Thus, the switch 36 would output the first control signal at 15:20, and would output the second control signal at 15:35.

In step S3, the microcontroller 38 enters the on state when the microcontroller 38 receives the first control signal, and then reads the RTC signal from the clock 382. The microcontroller 38 further compares the threshold time period and the time difference between receiving the first signal and the second signal. In one exemplary embodiment, the time difference between receiving the first signal and the second signal is about 15 minutes, and this period is more than the threshold time period (e.g., 100 ms). Thus, the microcontroller 38 transmits the open/closed status signals and the corresponding RTC signal to the storage 34 via the I2C port 344.

In step S4, during the verification process of the article(s), the RFID tag 32 reads the tracking data comprising the open/closed status signals and the corresponding RTC signal from the storage 34 via the RF port 342, and feeds back the tracking data to the reader 200 via RF communication.

The storage 34 temporarily stores the clock signals from the RFID tag 32 and the tracking data from the microcontroller 38 to facilitate communication between the RFID tag 32 and the microcontroller 38. Thus, the data storing ability of the microcontroller 38 is not needed, and then the microcontroller 38 will consume little power. Therefore, the article-tracking system 100 can be constantly re-used.

In other embodiments, the microcontroller 38 and the clock 382 are not integrated together. The microcontroller 38 is electronically connected to the clock 382 to set or reset the clock 382 according to the clock signals and reads the RTC signal from the clock 382.

The article-tracking system 100 can detect whether the package 10 is opened and then closed again, and the switch 36 outputs the first control signals and the second control signals accordingly. Thus, the microcontroller 30 reads the RTC signal from the clock 382, the storage 34 stores the open/closed status signals and the corresponding RTC signal, and the open/closed status signals and the corresponding RTC signal can be fed back to the reader 200 via the RFID tag 32. Therefore, the end-user, in cooperation with manufacturers and sellers, can directly know when and how many times the package 10 is opened, and the tracking of articles is sufficient to efficiently protect the articles from being stolen or replaced by fakes.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A control unit positioned approximate to a package and in electronic communication with a reader, comprising:
a radio frequency identification (RFID) tag;
a storage electronically connected to the FRID tag;
a switch; and
a microcontroller electronically connected to the storage and the switch;
wherein the switch outputs a first control signal to the microcontroller if the package is opened, the microcontroller outputs an open status signal and a corresponding real-time clock (RTC) signal to the storage according to the first control signal, the RFID tag sends the open status signal and the corresponding RTC signal from the storage to the reader.

2. The control unit as claimed in claim 1, wherein the RFID tag receives clock signals from the reader via radio frequency (RF) communication.

3. The control unit as claimed in claim 2, wherein the storage is an electrically erasable programmable read-only memory (EEPROM).

4. The control unit as claimed in claim 3, wherein the storage includes a radio frequency (RF) port and an inter-integrated circuit (I2C) port, the RF port is electronically connected to the RFID tag, and the I2C port is electronically connected to the microcontroller.

5. The control unit as claimed in claim 4, wherein the storage stores the clock signals from the RFID tag and the open status signal and the corresponding RTC signal from the microcontroller, the RFID tag reads the open status signal and the corresponding RTC signal via the RF port, and the microcontroller reads the clock signals via the I2C port.

6. The control unit as claimed in claim 5, further comprising a clock, wherein the microcontroller sets or resets the clock according to the clock signals, and reads the RTC signal from the clock.

7. The control unit as claimed in claim 1, wherein the switch outputs a second control signal to the microcontroller when the package is closed, the microcontroller outputs an closed status signal and a corresponding real-time clock (RTC) signal to the storage.

8. The control unit as claimed in claim 7, wherein the microcontroller predetermines a threshold time period, and the microcontroller determines whether a time difference between receiving the first control signal and the second control signal is less than the threshold time period.

9. The control unit as claimed in claim 8, wherein if the time difference between receiving the first control signal and the second control signal is more than the threshold time period, the microcontroller transmits the open/closed status signals and the corresponding RTC signal to the storage.

10. The control unit as claimed in claim 8, wherein if the time difference between receiving the first control signal and the second control signal is no more than the threshold time period, the microcontroller dose not transmit the open/closed status signals and the corresponding RTC signal to the storage.

11. An article-tracking method, comprising:
(a) outputting a first control signal via a switch positioned approximate to a package if the package is opened;
(b) outputting a real-time clock (RTC) signal from a microcontroller to a storage, according to the first control signal;
(c) reading the RTC signal from the storage by a radio frequency identification (RFID) tag; and
(d) feeding back the RTC signal to a reader via the RFID tag.

12. The article-tracking method as claimed in claim 11, further comprising receiving clock signals from the reader by the RFID tag, and storing the clock signals to the storage before the step (a).

13. The article-tracking method as claimed in claim 12, further comprising reading the clock signals from the storage by the microcontroller, and setting or resetting a clock of the microcontroller according to the clock signals.

14. The article-tracking method as claimed in claim 11, further comprising outputting a second control signal via the switch when the package is closed.

15. The article-tracking method as claimed in claim 14, further comprising outputting open/closed status signals to the storage by the microcontroller.

16. The article-tracking method as claimed in claim 15, further comprising:
determining whether a time difference between receiving the first signal and the second signal is less than a predetermined threshold time period;
outputting the open/closed status signals and the corresponding RTC signal to the storage by the microcontroller if the time difference is more than the predetermined threshold time period.

17. The article-tracking method as claimed in claim 15, further comprising reading the open/closed status signals from the storage by the RFID tag, and feeding back the open/closed status signals to the reader via the RFID tag.
